(19) United States
(12) Patent Application Publication
(10) Pub. No.: US 2025/0030358 A1
(43) Pub. Date: Jan. 23, 2025

(54) MOTOR DRIVER

(71) Applicant: ROHM CO., LTD., Kyoto-shi (JP)

(72) Inventor: Naoki TAKAHASHI, Kyoto-shi (JP)

(21) Appl. No.: 18/776,934

(22) Filed: Jul. 18, 2024

(30) Foreign Application Priority Data
Jul. 20, 2023 (JP) 2023-118545

(51) Int. Cl. H02P 3/08

(52) U.S. Cl. CPC H02P 3/08

(57) ABSTRACT

A motor driver for driving a motor includes: a half-bridge output stage including a high-side transistor and a low-side transistor, the motor being connected to a connection terminal to which the high-side transistor and the low-side transistor are connected; and a control circuit configured to monitor a terminal voltage of the connection terminal. The control circuit is configured to turn off the high-side transistor and turn on the low-side transistor, and initiate a brake mode to stop the motor. In the brake mode, when the terminal voltage is lower than a first setting voltage, the control circuit is configured to connect the connection terminal to an electric potential capable of maintaining the motor in a stopped state with the high-side transistor and the low-side transistor turned off.

### CROSS-REFERENCE TO RELATED APPLICATIONS

The present application is based on, and claims priority to, Japanese Patent Application No. 2023-118545 filed on Jul. 20, 2023, the entire contents of which are incorporated herein by reference.

### TECHNICAL FIELD

The present disclosure relates to a motor driver.

### BACKGROUND

A motor driver used for driving a brushed DC motor that has a brake mode for stopping the drive of a motor is known (see Patent Literature 1: JP 2021-029084A).

### BRIEF DESCRIPTION OF THE DRAWINGS

FIG. 1 is a configuration diagram of a motor driver according to an embodiment.

FIG. 2 is a circuit diagram of a brake circuit provided in a control circuit of the motor driver according to the embodiment.

FIG. 3 is a diagram illustrating a relationship between a terminal voltage V1 of a motor, and a signal voltage V2 inputted to an inverting input terminal of a comparator provided in the brake circuit, in a brake mode of the motor driver according to the embodiment.

FIG. 4 is a diagram illustrating a relationship between the terminal voltage V1 of the motor, and an output voltage V3 of the comparator provided in the brake circuit, in the brake mode of the motor driver according to the embodiment.

### DETAILED DESCRIPTION

A motor driver according to an embodiment will be described in detail below with reference to the drawings. Note that the embodiment described below illustrates a comprehensive or specific example. The numerical values, shapes, materials, components, and installation positions and connection configurations of components described in the following embodiment are examples and are not intended to be limited to the present disclosure. In addition, among the components in the following embodiment, components not described in the independent claim representing the broadest concept are described as optional components. Furthermore, dimensional ratios in the drawings are exaggerated for convenience of the description and are sometimes different from actual ratios. Furthermore, the following embodiment and modifications thereof sometimes include same components, and the same components will be given common reference numerals while omitting the overlapping description.

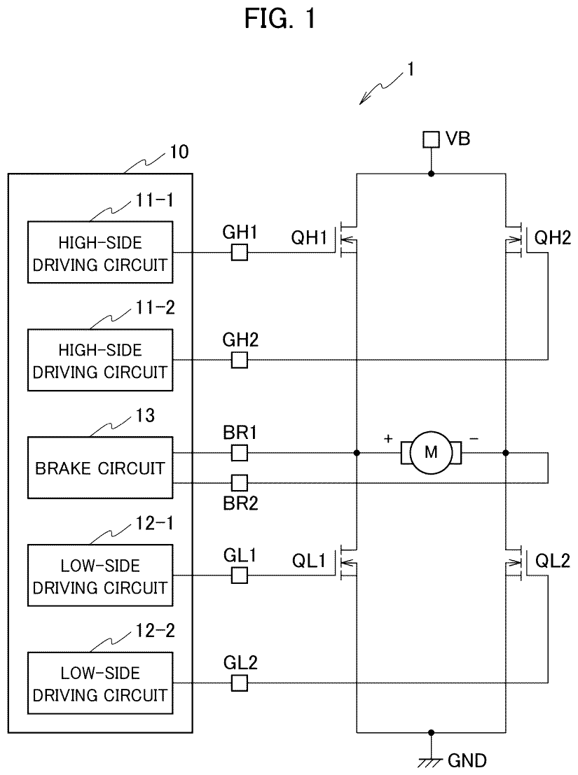

A basic configuration of a motor driver 1 according to an embodiment will be described with reference to FIG. 1.

The motor driver 1 includes an H-bridge circuit for driving a brushed DC motor M (hereinafter referred to as motor M), and a control circuit 10 for controlling the H-bridge circuit and the motor M.

The motor M is, for example, an on-vehicle motor used for driving windows, seats, seat belts, mirrors, wipers, and the like.

The H-bridge circuit includes a first half-bridge output stage including a first high-side transistor QH1 and a first low-side transistor QL1, and a second half-bridge output stage including a second high-side transistor QH2 and a second low-side transistor QL2. An N-channel MOSFET (Metal-Oxide-Semiconductor Field-Effect Transistor) can be used for the first high-side transistor QH1, the first low-side transistor QL1, the second high-side transistor QH2, and the second low-side transistor QL2, for example.

A first electrode (e.g., drain) of the first high-side transistor QH1 and a first electrode (e.g., drain) of the second high-side transistor QH2 are connected to a terminal VB, to which a DC power supply for driving the motor M is connected. A second electrode (e.g., source) of the first high-side transistor QH1 is connected in series to a first electrode (e.g., drain) of the first low-side transistor QL1. A second electrode (e.g., source) of the second high-side transistor QH2 is connected in series to a first electrode (e.g., drain) of the second low-side transistor QL2. A second electrode (e.g., source) of the first low-side transistor QL1 and a second electrode (e.g., source) of the second low-side transistor QL2 are connected to a ground potential (earth potential) GND. The connection point between the first high-side transistor QH1 and the first low-side transistor QL1 is connected to the positive terminal of the motor M, and the connection point between the second high-side transistor QH2 and the second low-side transistor QL2 is connected to the negative terminal of the motor M.

The control circuit 10 includes high-side driving circuits 11-1 and 11-2, low-side driving circuits 12-1 and 12-2, and a brake circuit 13. The high-side driving circuit 11-1 is connected to a control electrode (e.g., a gate) of the first high-side transistor QH1 via a terminal GH1, and controls the on and off of the first high-side transistor QH1. The high-side driving circuit 11-2 is connected to a control electrode (e.g., a gate) of the second high-side transistor QH2 via a terminal GH2, and controls the on and off of the second high-side transistor QH2. The low-side driving circuit 12-1 is connected to a control electrode (e.g., a gate) of the first low-side transistor QL1 via a terminal GL1, and controls the on and off of the first low-side transistor QL1. The low-side driving circuit 12-2 is connected to a control electrode (e.g., a gate) of the second low-side transistor QL2 via a terminal GL2, and controls the on and off of the second low-side transistor QL2. The brake circuit 13 is connected to the positive terminal of the motor M via a connection terminal BR1, and is connected to the negative terminal of the motor M via a connection terminal BR2.

When the motor M rotates in a positive direction, the control circuit 10 provides control in such a manner that the first high-side transistor QH1 and the second low-side transistor QL2 are turned on, and the second high-side transistor QH2 and the first low-side transistor QL1 are turned off. When the motor M rotates in the reverse direction, the control circuit 10 provides control in such a manner that the second high-side transistor QH2 and the first low-side transistor QL1 are turned on, and the first high-side transistor QH1 and the second low-side transistor QL2 are turned off. The description of a more detailed control method when the motor M is rotated is not omitted here since an existing method, such as a method described in Patent Literature 1 (JP 2021-29084 A), can be used.

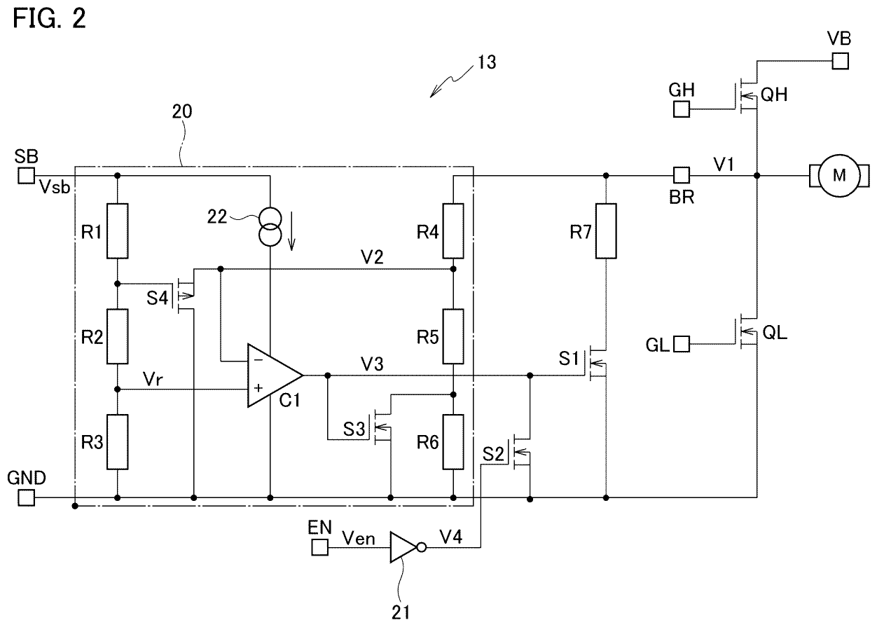

Next, a configuration of the brake circuit 13 provided in the control circuit 10 of the motor driver 1 according to the embodiment will be described with reference to FIG. 2. FIG. 2 is a circuit diagram of the brake circuit 13. The brake circuit 13 is used, in a brake mode for stopping the rotation of the motor M, in order to maintain the motor M in a stopped state by connecting the positive terminal and negative terminal of the motor M to the ground potential GND, thereby creating short circuit braking. Note that an electric potential to which the positive terminal and negative terminal of the motor M are connected is not limited to the ground potential GND, and may be an electric potential capable of maintaining the motor M in a stopped state.

In FIG. 2, since a half-bridge output stage has a common configuration to both the first half-bridge output stage and the second half-bridge output stage, the description is simplified from the description of FIG. 1 to a high-side transistor QH, a low-side transistor QL, a connection terminal BR, a terminal GH, and a terminal GL. A high-side driving circuit 11 for controlling the high-side transistor QH is connected to the terminal GH connected to the control electrode of the high-side transistor QH. A low-side driving circuit 12 for controlling the low-side transistor QL is connected to the terminal GL connected to the control electrode of the low-side transistor QL. The connection point between the high-side transistor QH and the low-side transistor QL is connected to the connection terminal BR, and to the terminal of the motor M.

The brake circuit 13 is configured as follows. A first electrode of a first switch S1 is connected to the connection terminal BR via a resistor R7, and a second electrode of the first switch S1 is connected to the ground potential GND. An output terminal of a comparator C1 is connected to a control electrode of the first switch S1. A first electrode of a second switch S2 is connected to the control electrode of the first switch S1, and a second electrode of the second switch S2 is connected to the ground potential GND. A control electrode of the second switch S2 is connected to a terminal EN via an inverter 21. A series circuit of resistors R4, R5, and R6 is connected between the connection terminal BR and the ground potential GND. In a third switch S3, a first electrode is connected to the connection point of the resistor R5 and resistor R6, a second electrode is connected to the ground potential GND, and a control electrode is connected to the output terminal of the comparator C1. For example, an N-channel MOSFET can be used for the first switch S1, the second switch S2, and the third switch S3. A series circuit of resistors R1, R2, and R3 is connected between a terminal SB and the ground potential GND. In a fourth switch S4, a first electrode is connected to the ground potential GND, a second electrode is connected to the connection point between the resistor R4 and the resistor R5 and to an inverting input terminal—of the comparator C1, and a control electrode is connected to the connection point between the resistor R1 and the resistor R2. For example, a P-channel MOSFET can be used for the fourth switch S4. A connection point of the resistor R2 and the resistor R3 is connected to a non-inverting input terminal+of the comparator C1. A positive power supply terminal of the comparator C1 is connected to the terminal SB via a DC current source 22, and a negative power supply terminal is connected to the ground potential GND.

A setting circuit 20 includes the comparator C1, the third switch S3, the fourth switch S4, and the resistors R1 to R6, configured as described above. The setting circuit 20 monitors a terminal voltage V1 inputted from the connection terminal BR to the brake circuit 13, and controls the on and off of the first switch S1 according to the terminal voltage V1.

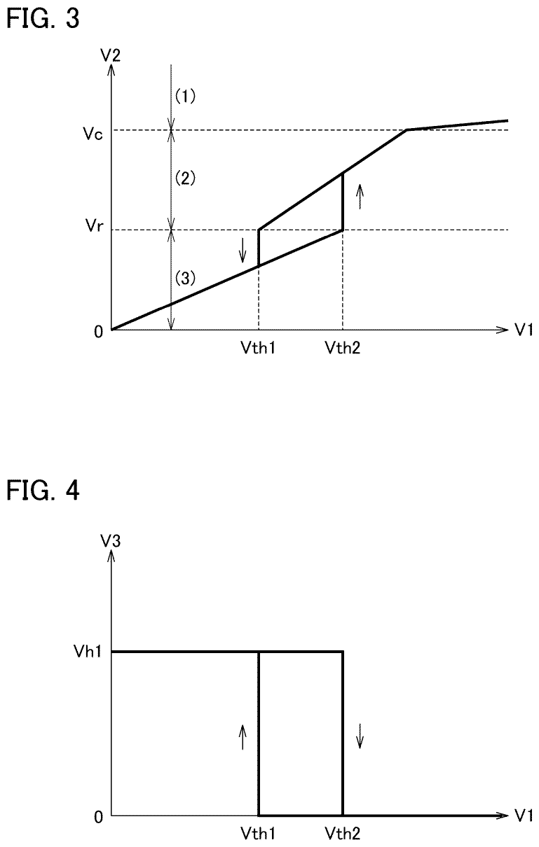

Next, the operation of the motor driver 1 in the brake mode will be described with reference to FIGS. 2, 3, and 4. FIG. 3 is a diagram illustrating a relationship between the terminal voltage V1 and a signal voltage V2 inputted to the inverting input terminal—of the comparator C1 in the brake mode of the motor driver 1. FIG. 4 is a diagram illustrating a relationship between the terminal voltage V1 and an output voltage V3 of the comparator C1 in the brake mode of the motor driver 1.

When the motor driver 1 is operated in the brake mode, an operation switching voltage Ven inputted to the terminal EN is Vh2 (HI potential, e.g. 5 V), and a predetermined control voltage Vsb is inputted to the terminal SB.

Since the operation switching voltage Ven is Vh2, the operation switching voltage Ven is inverted by the inverter 21. Since a voltage V4 inputted to the control electrode of the second switch S2 is zero (LO potential), the second switch S2 is in an off state. Since the second switch S2 is in the off state, the first switch S1 and the third switch S3 are in a controllable state using the output voltage V3 of the comparator C1.

When the predetermined control voltage Vsb is inputted to the terminal SB, a predetermined reference voltage Vr=Vsb×R3/(R1+R2+R3) is inputted to the non-inverting input terminal+of the comparator C1. Further, Vsb×(R2+R3)/(R1+R2+R3) is inputted to the control electrode of the fourth switch S4. Thus, the maximum value of the signal voltage V2 inputted to the inverting input terminal—of the comparator C1 can be suppressed by using a clamp voltage Vc=Vsb×(R2+R3)/(R1+R2+R3)+Vs4. Here, Vs4 is a threshold voltage of the fourth switch S4. Thus, by setting the clamp voltage Vc, the brake circuit 13 can be protected from high voltage. Note that when it is not necessary to set the clamp voltage Vc, the fourth switch S4 can be omitted.

In order to initiate the brake mode, the control circuit 10 shuts down the high-side driving circuit 11 to turn off the high-side transistor QH, and turns on the low-side transistor QL using the low-side driving circuit 12. Then, the terminal voltage V1 drops toward zero, and the rotation of the motor M is gradually stopped. When the terminal voltage V1 starts to drop, the control circuit 10 turns off the low-side transistor QL using the low-side driving circuit 12.

When the terminal voltage V1 is large and V1×(R5+R6)/(R4+R5+R6) is larger than the clamp voltage Vc, the voltage value of the signal voltage V2 is suppressed by the clamp voltage Vc, as illustrated in section (1) of FIG. 3. When the terminal voltage V1 further decreases and V1×(R5+R6)/(R4+R5+R6) becomes smaller than the clamp voltage Vc, the signal voltage V2=V1×(R5+R6)/(R4+R5+R6) is obtained as illustrated in section (2) of FIG. 3.

When the terminal voltage V1 has dropped to a first setting voltage Vth1, the signal voltage V2 becomes smaller than the reference voltage Vr inputted to the non-inverting input terminal+of the comparator C1. Then, as illustrated in FIG. 4, when the output voltage V3 of the comparator C1 is switched from zero (LO potential) to Vh1 (HI potential, e.g. 5 V), the first switch S1 and the third switch S3 are turned on. When the first switch S1 is turned on, the connection terminal BR is connected to the ground potential GND via the resistor R7, the terminal voltage V1 becomes zero, and the motor M enters a short circuit braking state.

When the third switch S3 is turned on, as illustrated in section (3) of FIG. 3, the signal voltage V2 inputted to the inverting input terminal—of the comparator C1 is switched to V2=V1×R5/(R4+R5). Consequently, a second setting voltage Vth2 larger than the first setting voltage Vth1 is set as a setting voltage capable of turning off the first switch S1 when the terminal voltage V1 rises. By setting the first setting voltage Vth1 and the second setting voltage Vth2 to different values, when the output voltage V3 of the comparator C1 is switched from zero to Vh1 or from Vh1 to zero, chattering can be prevented from occurring in the output voltage V3.

In the brake circuit 13, since the connection terminal BR is connected to the ground potential GND via the resistor R7, the short circuit braking of the motor M can be maintained with the low-side transistor QL turned off. When the short circuit braking of the motor M is maintained by turning on the low-side transistor QL, an internal power supply for turning on the low-side transistor QL or a circuit such as a gate driving circuit operates, and thus a consumption current of the order of several mA occurs. In contrast, since the short circuit braking of the motor M can be maintained with the low-side transistor QL turned off using the brake circuit 13, the consumption current caused by the operation of the low-side transistor QL can be suppressed.

When the terminal voltage V1 is large, if the first switch S1 constituted by the N-channel MOSFET is turned on and suddenly connected to the ground potential GND, there is a concern that the first switch S1 may be destroyed. Thus, with the setting circuit 20, destruction of the first switch S1 can be prevented by turning on the first switch S1 when the terminal voltage V1 has dropped to a predetermined first setting voltage Vth1.

Next, operation when the brake mode of the motor driver 1 is released will be described.

When the brake mode is released and an operation mode for operating the motor M is set, the operation switching voltage Ven inputted to the terminal EN is set to zero (LO potential). By setting the operation switching voltage Ven to zero, the operation switching voltage Ven is inverted by the inverter 21, and the voltage V4 inputted to the control electrode of the second switch S2 becomes a HI potential (e.g., 5V), so that the second switch S2 is switched on. When the second switch S2 is turned on, the control electrodes of the first switch S1 and the third switch S3 are connected to the ground potential GND, so that the first switch S1 and the third switch S3 are always set off regardless of the output voltage V3 of the comparator C1, and the switching operation is disabled. Thus, in the operation mode, the operation of the brake circuit 13 is disabled regardless of the value of the terminal voltage V1, and the motor M is prevented from entering the short circuit braking state.

When the high-side transistor QH is turned on, the terminal voltage V1 starts rising from zero. At this time, as illustrated in section (3) of FIG. 3, the signal voltage V2=V1×R5/(R4+R5) is inputted to the inverting input terminal—of the comparator C1.

When the terminal voltage V1 rises to the second setting voltage Vth2, larger than the first setting voltage Vth1, the signal voltage V2 becomes larger than the reference voltage Vr inputted to the non-inverting input terminal+of the comparator C1. Then, the output voltage V3 of the comparator C1 switches from Vh1 (HI potential) to zero (LO potential).

Note that the value of the control voltage Vsb and the resistance values of the resistors R1 to R7 can be optionally set according to the values of desired clamp voltage Vc, signal voltage V2, reference voltage Vr, first setting voltage Vth1, and second setting voltage Vth2. Although an example is illustrated where, as the setting circuit 20, the reference voltage Vr and the clamp voltage Vc are formed by dividing the control voltage Vsb via the resistors R1 to R3, and where the signal voltage V2 is formed by dividing the terminal voltage V1 via the resistors R4 to R6, this example is not limiting. It is sufficient that the setting circuit 20 can turn on the first switch S1 when the terminal voltage V1 has dropped to the predetermined first setting voltage Vth1. The configuration can be optionally determined by a designer.

In the motor driver 1 according to the embodiment, in the brake mode, by turning on the first switch S1 in the brake circuit 13, the connection terminal BR, which is the connection point between the high-side transistor QH and the low-side transistor QL, is connected to the ground potential GND via the resistor R7. By connecting the connection terminal BR to the ground potential GND via the resistor R7, the motor M can be in the short circuit braking state. Thus, since the high-side transistor QH and the low-side transistor QL are turned off, and the consumption current can be suppressed, the motor M can be maintained in the stopped state at a low consumption current.

In the motor driver 1 according to the embodiment, in the brake mode, the first switch S1 is turned on by the setting circuit 20 when the terminal voltage V1 has dropped to the predetermined first setting voltage Vth1 in the brake circuit 13. This can prevent destruction of the first switch S1.

The brake circuit 13 can, for example, be incorporated into a pre-driver IC (Integrated Circuit) used to drive the H-bridge circuit. By incorporating the brake circuit 13 into the pre-driver IC, the mounting area can be reduced compared to a case where only the brake circuit 13 is composed of an IC, and the consumption current and manufacturing cost can be reduced.

### Supplementary Note 1

The motor driver 1 for driving a motor M includes: a half-bridge output stage including the high-side transistor QH and the low-side transistor QL, the motor M being connected to the connection terminal BR to which the high-side transistor QH and the low-side transistor QL are connected; and the control circuit 10 that monitors the terminal voltage V1 of the connection terminal BR. The control circuit 10 is configured to turn off the high-side transistor QH and turn on the low-side transistor QL, and initiate a brake mode to stop the motor M. In the brake mode, when the terminal voltage V1 is lower than the first setting voltage Vth1, the control circuit 10 is configured to connect the connection terminal BR to an electric potential capable of maintaining the motor M in a stopped state with the high-side transistor QH and the low-side transistor QL turned off.

In the brake mode, by connecting the connection terminal BR to an electric potential capable of maintaining the stopped state of the motor M with the high-side transistor QH and the low-side transistor QL turned off, the stopped state of the motor M can be maintained at a low consumption current.

### Supplementary Note 2

In the motor driver 1 described in the supplementary note 1, the control circuit 10 includes the brake circuit 13 configured to maintain the motor M in the stopped state. The brake circuit 13 includes: the switch S1 in which the first electrode is connected to the connection terminal BR via the resistor R7, and the second electrode is connected to the ground potential GND; and the setting circuit 20 configured to control on and off of the switch S1 according to the terminal voltage V1. In the brake mode, the setting circuit 20 is configured to turn on the switch S1 when detecting that the terminal voltage V1 has dropped to the first setting voltage Vth1.

When the setting circuit 20 detects that the terminal voltage V1 has dropped to the first setting voltage Vth1 in the brake mode, it turns on the switch S1 to connect the connection terminal BR to the ground potential GND via the resistor R7, thereby maintaining the stopped state of the drive of the motor M.

### Supplementary Note 3

In the motor driver 1 described in the supplementary note 2, when the setting circuit 20 detects that the terminal voltage V1 has dropped to the first setting voltage Vth1 in the brake mode, the setting circuit 20 is configured to turn on the switch S1 and set a second setting voltage Vth2 to be larger than the first setting voltage Vth1, the second setting voltage Vth2 being capable of turning off the switch S1 when the terminal voltage V1 rises.

By setting the second setting voltage Vth2 to a value larger than the first setting voltage Vth1, chattering can be prevented from occurring when the switch S1 is switched between off and on.

### Supplementary Note 4

In the motor driver 1 described in the supplementary note 2 or 3, the control circuit 10 is configured to turn off the switch S1 when releasing the brake mode.

By turning off the switch S1 when releasing the brake mode, the short braking state of the motor M is released.

### Supplementary Note 5

In the motor driver 1 described in the supplementary note 4, the switch S1 is always off during an operation mode where the brake mode has been released.

Since the switch S1 is always off in the operation mode, even if the setting circuit 20 is operated in the operation mode, the motor M can be prevented from entering the short circuit braking state.

### Supplementary Note 6

In the motor driver 1 described in any one of the supplementary notes 1 to 5, the control circuit 10 includes the high-side driving circuit 11 that drives the high-side transistor QH. On shifting to the brake mode, the control circuit 10 is configured to cause the terminal voltage V1 to drop toward zero by shutting down the high-side driving circuit 11.

Although the present disclosure has been described in detail, it is obvious to those skilled in the art that the present disclosure is not limited to the embodiments described herein. The present disclosure can be implemented as modifications and variations without departing from the spirit and scope of the present disclosure as defined by the claims. Therefore, the description of the present disclosure is for the purpose of illustration and does not have any restrictive meaning to the present disclosure.

1. A motor driver for driving a motor, comprising:
a half-bridge output stage including a high-side transistor and a low-side transistor, the motor being connected to a connection terminal to which the high-side transistor and the low-side transistor are connected; and
a control circuit configured to monitor a terminal voltage of the connection terminal, wherein
the control circuit is configured to turn off the high-side transistor and turn on the low-side transistor, and initiate a brake mode to stop the motor, and
in the brake mode, when the terminal voltage is lower than a first setting voltage, the control circuit is configured to connect the connection terminal to an electric potential capable of maintaining the motor in a stopped state with the high-side transistor and the low-side transistor turned off.

2. The motor driver according to claim 1, wherein
the control circuit includes a brake circuit configured to maintain the motor in the stopped state, wherein
the brake circuit comprises:
a switch in which a first electrode is connected to the connection terminal via a resistor, and a second electrode is connected to a ground potential; and
a setting circuit configured to control on and off of the switch according to the terminal voltage, wherein
in the brake mode, the setting circuit is configured to turn on the switch when detecting that the terminal voltage has dropped to the first setting voltage.

3. The motor driver according to claim 2, wherein
when the setting circuit detects that the terminal voltage has dropped to the first setting voltage in the brake mode, the setting circuit is configured to turn on the switch and set a second setting voltage to be larger than the first setting voltage, the second setting voltage being capable of turning off the switch when the terminal voltage rises.

4. The motor driver according to claim 2, wherein
the control circuit is configured to turn off the switch when releasing the brake mode.

5. The motor driver according to claim 4, wherein
the switch is always off during an operation mode where the brake mode has been released.

6. The motor driver according to claim 1, wherein
the control circuit includes a high-side driving circuit that drives the high-side transistor, and
on shifting to the brake mode, the control circuit is configured to cause the terminal voltage to drop toward zero by shutting down the high-side driving circuit.
